(19) United States
(12) Patent Application Publication
(10) Pub. No.: US 2012/0127145 A1
(43) Pub. Date: May 24, 2012

(54) SOURCE DRIVING CIRCUIT, DISPLAY DEVICE INCLUDING THE SOURCE DRIVING CIRCUIT AND OPERATING METHOD OF THE DISPLAY DEVICE

(75) Inventors: Minhwa JANG, Yongin-si (KR); Jongseon KIM, Seongnam-si (KR); Byungtae KIM, Hwaseong-si (KR)

(73) Assignee: SAMSUNG ELECTRONICS CO., LTD., Suwon-si (KR)

(21) Appl. No.: 13/241,664

(22) Filed: Sep. 23, 2011

(30) Foreign Application Priority Data
Nov. 19, 2010 (KR) 10-2010-0115817

(51) Int. Cl. G09G 5/00

(52) U.S. Cl. 345/211; 345/204

(57) ABSTRACT

A display device and its operating method are provided. The display device and its driving method are capable of operating at a fail mode according to an image signal. The display device includes a master timing controller that generates a first substituting image signal and a fail operating signal, and a slave timing controller that generates a second substituting image signal in response to the fail operating signal.

### CROSS-REFERENCE TO RELATED APPLICATION

This application claims priority from Korean Patent Application No. 10-2010-0115817 filed Nov. 19, 2010, the entirety of which is incorporated by reference herein.

### BACKGROUND

1. Field

Exemplary embodiments relate to a display device, and more particularly, relate to a source driving circuit operating at a fail mode according to an image signal, a display device including the source driving circuit, and an operating method of the display device.

2. Description of the Related Art

Various planar display devices have been developed which have less volume and weight than that of a related art cathode ray tube (CRT). Such planar display devices may comprise a plasma display panel (PDP), a liquid crystal display (LCD) device, a field emission display device, an organic light emitting display device, and the like.

The LCD device may display images by applying voltage to a liquid crystal injected between two glass substrates. That is, the light transmission of the liquid crystal injected between two glass substrates may be adjusted according to applied voltage. Images may be displayed according to the light transmission of the liquid crystal.

The organic light emitting display device may display images using an organic light emitting diode (OLED), which has an organic material layer, as an illuminating material, between an anode injecting holes and a cathode injecting electrons. The OLED produces its own light through recombination of electrons and holes in the organic material layer. At this time, the strength of light may be determined based upon the amount of current flowing into the OLED.

### SUMMARY

According to an aspect of an exemplary embodiment, there is provided a source driving circuit of a display device which comprises a master timing controller controlling a first source driver according to a first image signal; and a slave timing controller controlling a second source driver according to a second image signal. The master timing controller generates a fail operating signal and a first substituting image signal when the first image signal is judged to be abnormal or in response to a fail detecting signal. The slave timing controller generates the fail detecting signal when the second image signal is judged to be abnormal, and generates a second substituting image signal in response to the fail operating signal.

According to another aspect of an exemplary embodiment, there is provided a display device comprising a display panel including a first display area and a second display area; and a source driving circuit driving the first and second display areas according to a first image signal and a second image signal, respectively. The source driving circuit comprises a master timing controller generating a fail operating signal and a first substituting image signal when the first image signal is judged to be abnormal or in response to a fail detecting signal; a slave timing controller generating the fail detecting signal when the second image signal is judged to be abnormal and generating a second substituting image signal in response to the fail operating signal; a first source driver receiving the first substituting image signal to display a substituting image at the first display area; and a second source driver receiving the second substituting image signal to display a substituting image at the second display area.

According to still another aspect of an exemplary embodiment, there is provided an operating method of a display device including a plurality of timing controllers. The operating method comprises generating a fail operating signal when a fail is detected from at least one of the plurality of timing controllers, according to an image signal received from an external device; generating substituting image signals via the plurality of timing controllers when the fail operating signal is generated; and displaying a substituting image according to the substituting image signals.

### BRIEF DESCRIPTION OF THE FIGURES

The above and other aspects will become apparent from the following description with reference to the following figures, wherein like reference numerals refer to like parts throughout the various figures unless otherwise specified, and wherein

FIG. 1 is a block diagram showing a display device according to an exemplary embodiment.

FIG. 2 is a block diagram showing the first to sixth timing controllers illustrated in FIG. 1.

FIG. 3 is a block diagram showing a display device according to an exemplary embodiment.

FIG. 4A is a flow chart for describing a driving method of a display device according to an exemplary embodiment.

FIG. 4B is a flow chart for describing an operation of a display device in FIG. 3 at a fail mode.

FIG. 5 is a block diagram showing the first and second timing controller in FIG. 3 according to an exemplary embodiment.

FIG. 6 is a diagram for describing an operation of timing controllers when a fail detecting signal is produced from the first slave fail detector.

FIG. 7 is a diagram for describing an operation of timing controllers when a fail detecting signal is produced from a master fail detector.

FIG. 8 is a timing diagram for describing a case in which fails are detected from a master timing controller and the first slave timing controller in FIG. 5.

FIG. 9 is a block diagram showing the first and second timing controllers in FIG. 3 according to an exemplary embodiment.

FIG. 10 is a timing diagram for describing a case in which fails are detected from a master timing controller and the first slave timing controller in FIG. 9.

FIG. 11 is a block diagram showing a display device according to an exemplary embodiment.

FIG. 12 is a block diagram showing a computing system including a display device according to an exemplary embodiment.

### DETAILED DESCRIPTION OF EXEMPLARY EMBODIMENTS

Exemplary embodiments are described more fully hereinafter with reference to the accompanying drawings. The exemplary embodiments may, however, be embodied in many different forms and should not be construed as limited to the exemplary embodiments set forth herein. Rather, these exemplary embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

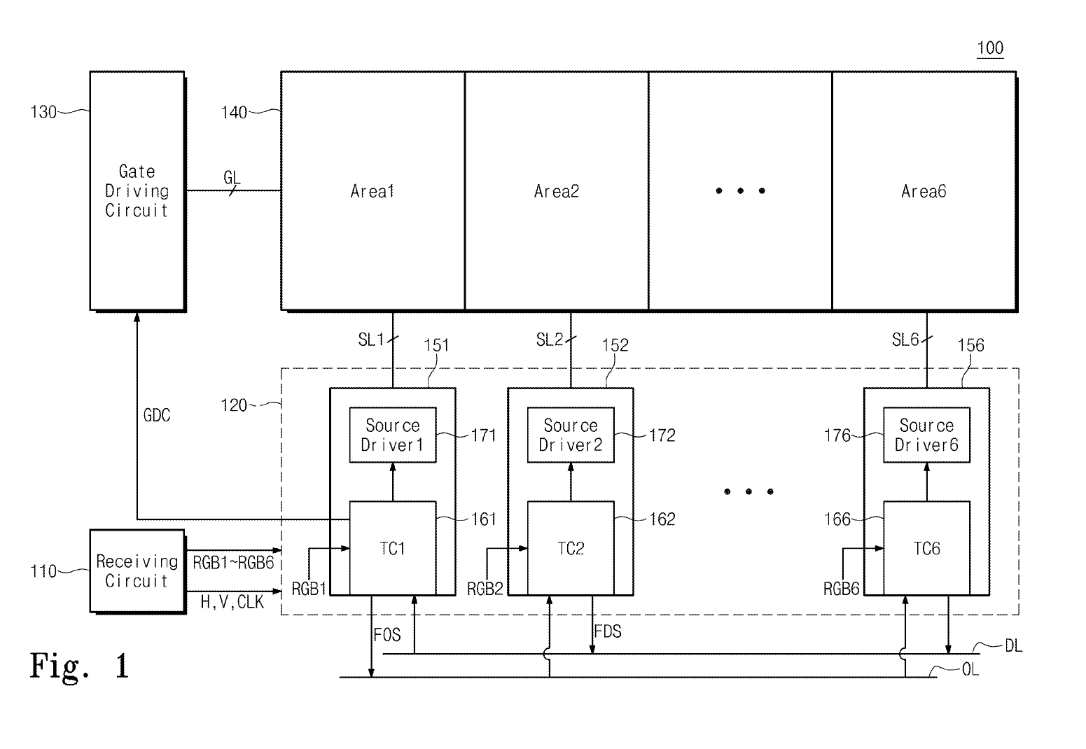

FIG. 1 is a block diagram showing a display device according to an exemplary embodiment. A display device 100 includes a receiving circuit 110, a source driving circuit 120, a gate driving circuit 130, and a display panel 140.

The receiving circuit 110 supplies the source driving circuit 120 with an image signal RGB and the following control signals received from an external device: horizontal synchronization signal H, vertical synchronization signal V, and main clock signal CLK. For example, although not shown in FIG. 1, the receiving circuit 110 may receive the image signal RGB and the control signals H, V, and CLK from a central processing unit (CPU) or a graphic processor unit (GPU) which is included within an electronic device displaying images through the display panel 140. In an exemplary embodiment, the receiving circuit 110 may be configured to lower voltage levels of the image signal RGB and the control signals H, V, and CLK and to increase their frequencies using a low voltage differential signaling (LVDS) manner, a transition minimized differential signaling (TMDS) manner, and the like.

The receiving circuit 110 divides the image signal RGB into the first to sixth image signals RGB1 to RGB6. The receiving circuit 110 transfers the first to sixth image signals RGB1 to RGB6 to the first to sixth source driving parts 151 to 156, respectively.

The source driving circuit 120 is electrically connected with the display panel 140 and the gate driving circuit 130. The source driving circuit 120 receives the image signal RGB and the control signals H, V, and CLK from the receiving circuit 110. The source driving circuit 120 drives the display panel 140 in response to the received control signals H, V, and CLK.

The source driving circuit 120 includes the first to sixth source driving parts 151 to 156, which operate in response to the control signals H, V, and CLK. The first to sixth source driving parts 151 to 156 receive the first to sixth image signals RGB1 to RGB6, respectively, and display images on the first to sixth display areas Area1 to Area6 of the display panel 140.

The first to sixth source driving parts 151 to 156 include the first to sixth timing controllers 161 to 166, respectively. The first to sixth source driving parts 151 to 156 also include the first to sixth source drivers 171 to 176, respectively.

Any one of the first to sixth timing controllers 161 to 166 can control the gate driving circuit 130. In FIG. 1, there is illustrated an example that the first timing controller 161 controls the gate driving circuit 130.

The first timing controller 161 transfers a gate driving control signal GDC to the gate driving circuit 130 in response to the vertical synchronization signal V. The gate driving circuit 130 sequentially activates gate lines GL in response to the gate driving control signal GDC.

The first to sixth timing controllers 161 to 166 control the first to sixth source drivers 171 to 176 in response to the horizontal synchronization signal H and the main clock signal CLK. The first to sixth timing controllers 161 to 166 provide the first to sixth image signals RGB1 to RGB6 to the first to sixth source drivers 171 to 176 in response to the main clock signal CLK, respectively. That is, the first to sixth timing controllers 161 to 166 may provide the first to sixth image signals RGB1 to RGB6 sampled according to the main clock signal CLK, respectively.

Each timing controller may provide a source timing control signal (not shown) to each source driver in response to the horizontal synchronization signal H. Each source driver may display a received image signal in response to the source timing control signal.

The first to sixth source drivers 171 to 176 are connected with the display panel 140 through the first to sixth source lines SL1 to SL6, respectively. The first to sixth source drivers 171 to 176 may drive the first to sixth display areas Area1 to Area6, respectively.

The first to sixth source drivers 171 to 176 may apply voltages to the first to sixth source lines SL1 to SL6 based upon supplied image signals, respectively. In an exemplary embodiment, when each of the gate lines GL is activated, the first source driver 171 may apply a voltage to the first source lines SL1 based upon the first image signal RGB1. This enables an image to be displayed through pixels within the first display area Area1. The second to sixth source drivers 172 to 176 may be configured to operate the same as the first source driver 171.

The display panel 140 is divided into the first to sixth display areas Area1 to Area6, each of which includes a plurality of pixels (not shown). An image may be displayed on the first to sixth display areas Area1 to Area6 according to voltage levels provided from the first to sixth source drivers 171 to 176. In an exemplary embodiment, the display panel 140 may be a plasma display panel (PDP), a liquid crystal display (LCD) device, a field emission display device, an organic light emitting display device, or the like.

The first to sixth timing controllers 161 to 166 receive the first to sixth image signals RGB1 to RGB6 to perform a fail detecting function. The first to sixth timing controllers 161 to 166 receive the control signals H, V, and CLK to perform a fail detecting function.

The fail detecting function means a function of recognizing whether a received image signal does not meet a standard or whether a control signal is abnormal. In an exemplary embodiment, the first to sixth timing controllers 161 to 166 may detect a fail by checking whether the first to sixth image signals RGB1 to RGB6 include a predetermined data amount. For example, in the event that no image is displayed through all pixels within the first display area Area1 using the first image signal RGB1, the first timing controller 161 detects a fail. The first timing controller 161 may check whether the first image signal RGB1 meets a length and breadth standard. Alternatively, the first to sixth timing controllers 161 to 166 may detect, as a fail, whether an input of the main clock signal CLK is stopped or its frequency is abnormal.

If the fail is detected, the first to sixth timing controllers 161 to 166 may operate at a fail mode, respectively. That is, the first to sixth timing controllers 161 to 166 may control the first to sixth source drivers 171 to 176 such that a substituting image is displayed on the display panel 140. For example, an all-black image or an all-white image may be displayed on the display panel 140. The noise phenomenon is not displayed since a substituting image is displayed on the display panel 140.

The first to sixth timing controllers 161 to 166 are connected with a detecting line DL and an operating line OL. In an exemplary embodiment, if any one of the first to sixth timing controllers 161 to 166 detects a fail, the first to sixth timing controllers 161 to 166 all operate at a fail mode.

It is assumed that any one of the first to sixth timing controllers 161 to 166 may be a master timing controller. Further, it is assumed that the remaining timing controllers other than the master timing controller are slave timing controllers. In FIG. 1, the first timing controller 161 is assumed to be a master timing controller. The second to sixth timing controllers 162 to 166 are assumed to be a slave timing controller.

The master timing controller 161 operates at a fail mode when a fail is detected. Upon detection of the fail, the master timing controller 161 sends a fail operating signal FOS to the slave timing controllers through the operating line OL.

Upon detection of a fail, the slave timing controllers 162 to 166 generate a fail detecting signal FDS, which is sent to the master timing controller 161 through the detecting line DL. FIG. 1 shows the case that a fail detecting signal FDS is generated from the second timing controller 162.

The master timing controller 161 enters a fail mode in response to the fail detecting signal FDS. The master timing controller 161 responds to the fail detecting signal FDS to send the fail operating signal FOS through the operating line OL.

The slave timing controllers 162 to 166 receive the fail operating signal FOS through the operating line OL. The slave timing controllers 162 to 166 enter the fail mode in response to the fail operating signal FOS.

If no fail is detected, the first to sixth timing controllers 161 to 166 operate at a normal mode. That is, when the first to sixth image signals RGB1 to RGB6 are normal, the first to sixth timing controllers 161 to 166 operate at a normal mode. The first to sixth timing controllers 161 to 166 may generate the first to sixth image signals RGB1 to RGB6. The first to sixth source driver 171 to 176 may display an image on the first to sixth display areas Area1 to Area6, respectively.

In accordance with an exemplary embodiment, if a fail is detected by any one of the first to sixth timing controllers 161 to 166, the first to sixth timing controllers 161 to 166 all enter a fail mode. Accordingly, at a fail mode, a substituting image may be displayed on the first to sixth display areas Area1 to Area6 of the display panel 140.

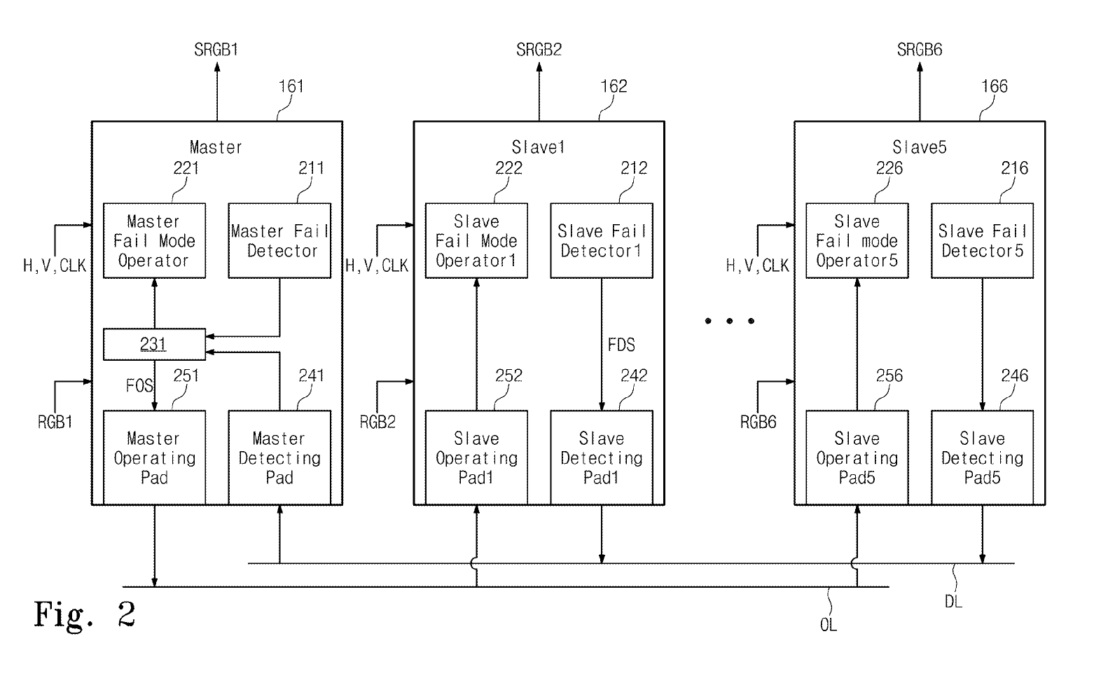

FIG. 2 is a block diagram showing the first to sixth timing controllers illustrated in FIG. 1. Referring to FIG. 2, the first to sixth timing controllers 161 to 166 are connected with the detecting line DL and the operating line OL. As described with reference to FIG. 1, the remaining timing controllers 162 to 166 are assumed to be slave timing controllers.

The first timing controller 161, that is, a master timing controller 161, includes a master fail detector 211, and the first to fifth slave timing controllers 162 to 166 include first to fifth slave fail detectors 212 to 216, respectively. The master fail detector 211 and the first to fifth slave fail detectors 212 to 216 may detect a fail based upon the first to sixth image signals RGB1 to RGB6. Further, the master fail detector 211 and the first to fifth slave fail detectors 212 to 216 may detect a fail based upon control signals H, V, and CLK.

In FIG. 2, an exemplary embodiment is shown in which a fail detecting signal FDS is generated from the first slave fail detector 212. But, all of the fail detectors 211 to 216 can be configured to generate the fail detecting signal FDS.

The master timing controller 161 includes a master fail mode operator 221. The first to fifth slave timing controllers 162 to 166 include first to fifth slave fail mode operators 222 to 226, respectively. Upon receiving the fail operating signal FOS, the mode operators 221 to 226 may generate first to sixth substituting image signals SRGB1 to SRGB6, respectively. The first to sixth substituting image signals SRGB1 to SRGB6 may be sent to the first to sixth source drivers 171 to 176 (refer to FIG. 1).

The master timing controller 161 further includes a master operating signal generator 231, a master detecting pad 241, and a master operating pad 251. The master operating signal generator 231 generates a fail operating signal FOS when a fail detecting signal FDS is received from the master detecting pad 241. The master operating signal generator 231 generates the fail operating signal FOS when the fail detecting signal FDS is received from the master fail detector 211.

The master detecting pad 241 transfers the fail detecting signal FDS received through a detecting line DL to the master operating signal generator 231. The master operating pad 251 transfers the fail operating signal FOS generated by the master operating signal generator 231 to the operating line OL.

The first slave timing controller 162 further includes the first slave detecting pad 242 and the first slave operating pad 252. The first slave detecting pad 242 transfers the fail detecting signal FDS generated by the first slave fail detector 212 to the detecting line DL. The first slave operating pad 252 transfers the fail operating signal FOS received via the operating line OL to the first slave fail mode operator 222. The second to fifth slave timing controllers 163 to 166 may be configured to be the same as the first slave timing controller 162.

If the first slave fail detector 212 detects a fail, it may produce the fail detecting signal FDS, which is transferred to the detecting line DL through the first slave detecting pad 242. In the event that the fail detecting signal FDS is produced by at least one of the first to fifth slave timing controllers 162 to 166, it may be sent to the master timing controller 161.

The master timing controller 161 generates the first substituting image signal SRGB1 in response to the fail detecting signal FDS. The master timing controller 161 generates the fail operating signal FOS in response to the fail detecting signal FDS.

In particular, the master detecting pad 241 receives the fail detecting signal FDS to send it to the master operating signal generator 231. The master operating signal generator 231 produces the fail operating signal FOS in response to the fail detecting signal FDS. The fail operating signal FOS is sent to the operating line OL via the master operating pad 251. Further, the fail operating signal FOS is sent to the master fail mode operator 221. The master fail mode operator 221 may generate the first substituting image signal SRGB1 in response to the fail operating signal FOS.

The first to fifth slave fail mode operators 222 to 226 receive the fail operating signal FOS via the first to fifth slave operating pads 252 to 256. The first to fifth slave fail mode operators 222 to 226 may produce the second to sixth substituting image signals SRGB2 to SRGB6.

As a result, the first to sixth source drivers 171 to 176 (refer to FIG. 1) may receive the first to sixth substituting image signals SRGB1 to SRGB6, respectively. The first to sixth source drivers 171 to 176 may display an image on the first to sixth display areas Area1 to Area6, respectively, based on the substituting image signals SRGB1 to SRGB6.

Upon detecting a fail, the second to fifth slave fail detectors 213 to 216 may operate to be the same as described via the first slave fail detector 212, and description thereof is thus omitted.

If it is assumed that a fail is detected by the master fail detector 211, the master fail detector 211 may send the fail detecting signal FDS to the master operating signal generator 231. The master operating signal generator 231 may generate the fail operating signal FOS in response to the fail detecting signal FDS. The fail operating signal FOS is sent to the operating line OL via the master operating pad 251.

Further, the fail operating signal FOS may be transferred to the master fail mode operator 221. The master fail mode operator 221 may make the first substituting image signal SRGB1 in response to the fail operating signal FOS.

The first to fifth slave fail mode operators 222 to 226 may receive the fail operating signal FOS via the first to fifth slave operating pads 252 to 256, respectively. The first to fifth slave fail mode operators 222 to 226 may make the second to sixth substituting image signals SRGB2 to SRGB6 in response to the fail operating signal FOS.

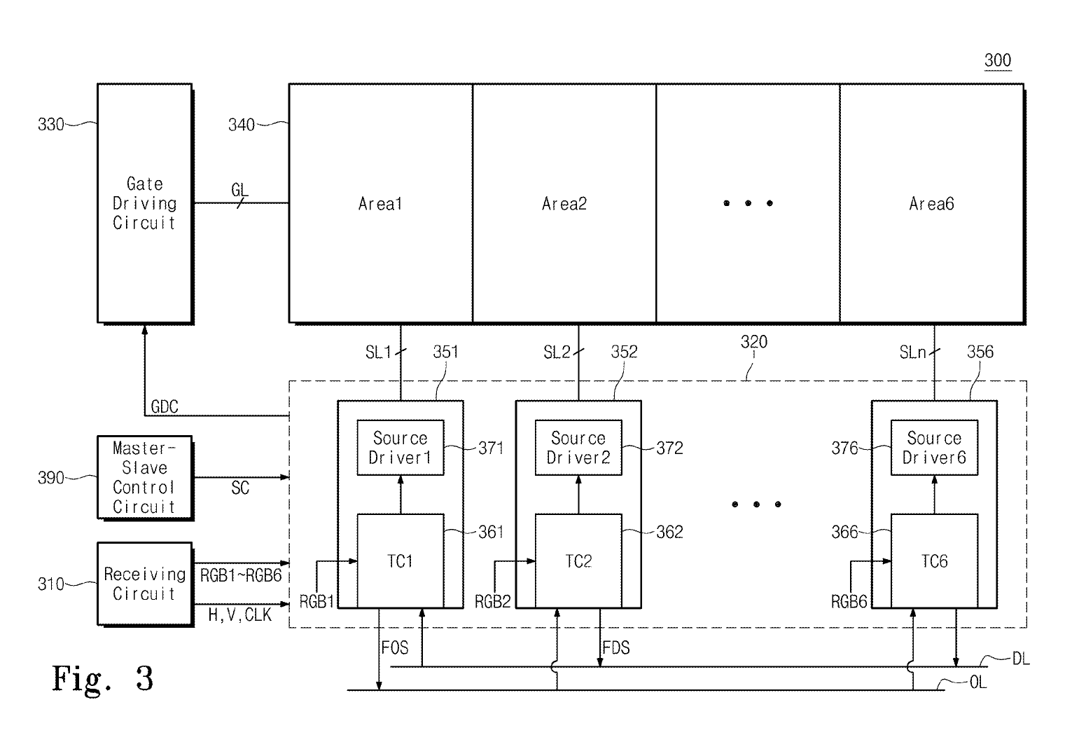

FIG. 3 is a block diagram showing a display device according to an exemplary embodiment. Referring to FIG. 3, a display device 300 includes a receiving circuit 310, a source driving circuit 320, a gate driving circuit 330, a display panel 340, and a master-slave control circuit 390.

The receiving circuit 310 is configured to be identical to that in FIG. 1. That is, the receiving circuit 310 transfers an image signal and control signals H, V, and CLK received from an external device to the source driving circuit 320.

The source driving circuit 320 includes the first to sixth source driving parts 351 to 356. The source driving circuit 320 receives a state control signal SC from the master-slave control circuit 390.

The first to sixth source driving parts 351 to 356 include the first to sixth timing controllers 361 to 366, respectively. The first to sixth source driving parts 351 to 356 include the first to sixth source drivers 371 to 376, respectively.

Each of the first to sixth timing controllers 361 to 366 operates a master timing controller or a slave timing controller according to the state control signal SC. That is, depending upon the state control signal SC, one (for example, the first timing controller 361) of the first to sixth timing controllers 361 to 366 is a master timing controller, and the remaining timing controllers (for example, 362 to 366) are a slave timing controller.

If a fail is detected by the master timing controller 361, the master timing controller 361 provides a fail operating signal FOS. The master timing controller 361 may send the first substituting image signal (not shown) to the first source driver 371. Likewise, the slave timing controllers 362 to 366 may produce the second to sixth substituting image signals (not shown) in response to the fail operating signal FOS, respectively.

If a fail is detected from the slave timing controllers 362 to 366, the slave timing controllers 362 to 366 may send the fail detecting signal FDS. The master timing controller 361 may receive the fail detecting signal FDS via the detecting line DL. If any one of the slave timing controllers 362 to 366 detects a fail, the master timing controller 361 may receive the fail detecting signal FDS. The master timing controller 361 sends the fail operating signal FOS to the operating line OL in response to the fail detecting signal FDS. The master timing controller 361 may transfer the first substituting image signal (not shown) to the first source driver 371. The slave timing controllers 362 to 366 may produce the second to sixth substituting image signals (not shown) in response to the fail operating signal FOS.

The gate driving circuit 330 is configured to operate identically to that in FIG. 1. The gate driving circuit 330 may operate in response to a control of any one of the first to sixth timing controllers 361 to 366. That is, the gate driving circuit 330 receives a gate driving control signal GDC from any one of the first to sixth timing controllers 361 to 366. The gate driving circuit 330 sequentially activates gate lines GL in response to the gate driving control signal GDC.

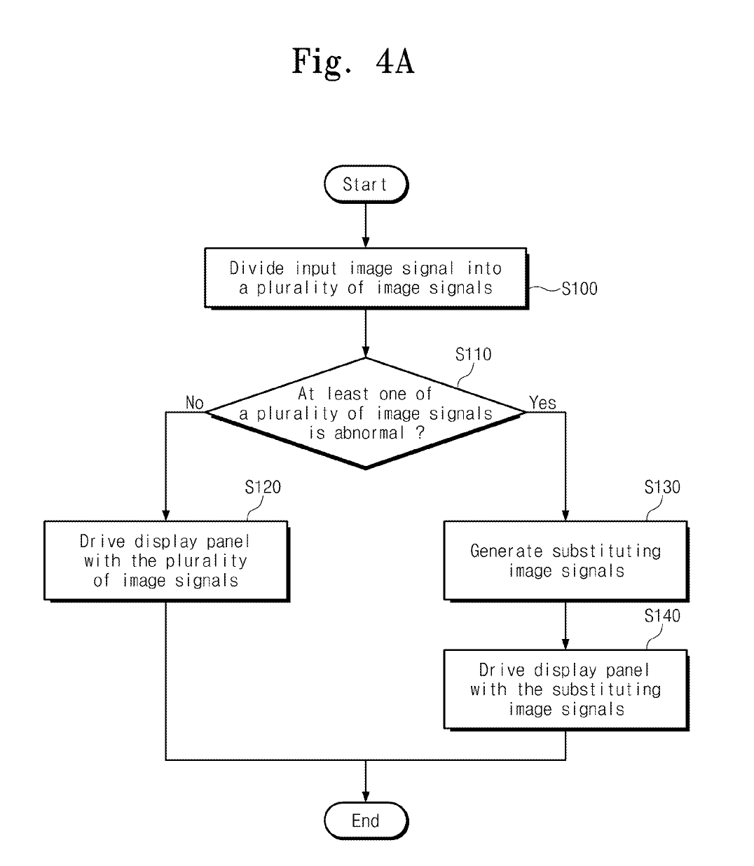

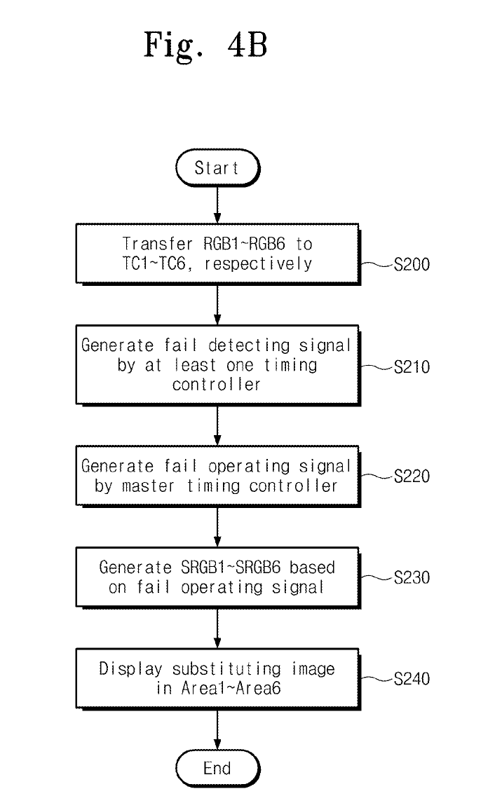

FIG. 4A is a flow chart for describing a driving method of a display device according to an exemplary embodiment. Below, a driving method of a display device according to exemplary embodiments of the inventive concept will be more fully described with reference to accompanying drawings.

In step S100, an input image signal may be divided into a plurality of, for example, six image signals RGB1 to RGB6. This may be performed by a receiving circuit 110 in FIG. 1 or 310 in FIG. 3. In step S110, it is judged whether at least one of the plurality of image signals RGB1 to RGB6 is abnormal. This may be performed by a source driving circuit 120 in FIG. 1 or 320 in FIG. 3. Although not shown in figures, the judging can be done by the receiving circuit 110 in FIG. 1 or 310 in FIG. 3 or by a circuit placed between the receiving circuit and the source driving circuit. If the plurality of image signals RGB1 to RGB6 is judged to be normal, the driving method proceeds to step S120, in which a display panel 140 in FIG. 1 or 340 in FIG. 3 is driven with the plurality of image signals through the source driving circuit 120 in FIG. 1 or 320 in FIG. 3. Afterwards, the driving method ends.

Returning to step S110, if at least one of the plurality of image signals RGB1 to RGB6 is judged to be abnormal, the driving method proceeds to step S130, in which substituting image signals SRGB1 to SRGB6 are generated by the source driving circuit 120 in FIG. 1 or 320 in FIG. 3, based upon the judgment result. And then, in step S140, the display panel 140 in FIG. 1 or 340 in FIG. 3 is driven with the substituting image signals through the source driving circuit 120 in FIG. 1 or 320 in FIG. 3. Afterwards, the driving method ends.

FIG. 4B is a flow chart for describing an operation of a display device in FIG. 3 at a fail mode.

Referring to FIGS. 1 to 3 and 4B, in step S200, the first to sixth image signals RGB1 to RGB6 are transferred to the first to sixth timing controllers 361 to 366 from a receiving circuit 310, respectively. Further, the first to sixth timing controllers 361 to 366 may receive control signals H, V, and CLK from the receiving circuit 310.

The first to sixth timing controllers 361 to 366 may detect the first to sixth image signals RGB1 to RGB6, respectively. The first to sixth timing controllers 361 to 366 may also detect the control signals H, V, and CLK. In step S210, a fail detecting signal FDS is generated from at least one of the first to sixth timing controllers 361 to 366.

The first timing controller 361 is a master timing controller. In step S220, the first timing controller 361 generates a fail operating signal FOS in response to the fail detecting signal FDS.

If a fail is detected from the second to sixth timing controllers 362 to 366, the first timing controller 361 may receive the fail detecting signal FDS via a detecting line DL. The first timing controller 361 generates the fail operating signal FOS in response to the fail detecting signal FDS.

In the event that a fail is detected from the first timing controller 361, the first timing controller 161/361 generates the fail operating signal FOS without receiving the fail detecting signal FDS via the detecting line DL.

The fail operating signal FOS may be transferred to the second to sixth timing controllers 362 to 366 via an operating line OL. The second to sixth timing controllers 362 to 366 generate the second to sixth substituting image signals SRGB1 to SRGB6 in response to the fail operating signal FOS. The first timing controller 361 may generate the first substituting image signal SRGB1 in response to the fail operating signal FOS. That is, in step S230, the first to sixth timing controllers 361 to 366 produce the first to sixth substituting image signal SRGB1 to SRGB6 in response to the fail operating signal FOS, respectively.

The first to sixth source drivers 371 to 376 receive the first to sixth substituting image signals SRGB1 to SRGB6, respectively. In step 240, the first to sixth source drivers 371 to 376 may display a substituting image on the first to sixth display areas Area1 to Area6 based on the first to sixth substituting image signals SRGB1 to SRGB6.

The operation described with reference to FIG. 4B may be applied identically to the exemplary embodiment shown in FIG. 1. According to an exemplary embodiment, the master timing controller 361 and the slave timing controllers 362 to 366 may be fabricated using the same process. It is possible to classify the master timing controller 361 and the slave timing controllers 362 to 366 using a state control signal SC.

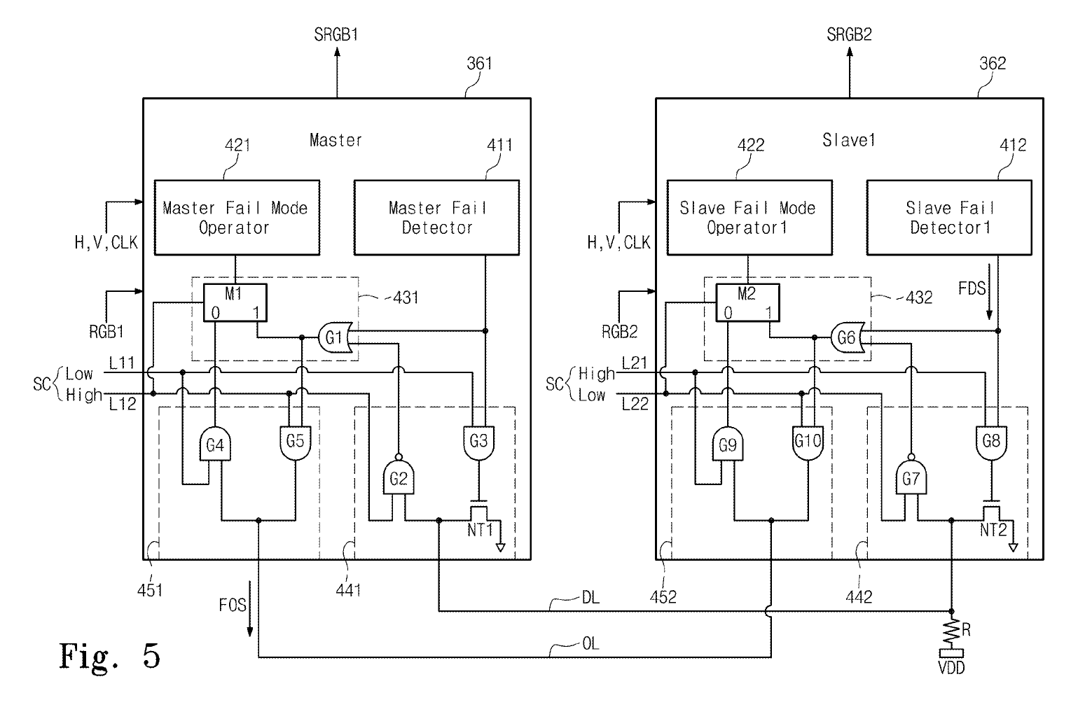

FIG. 5 is a block diagram showing the first and second timing controller in FIG. 3 according to an exemplary embodiment.

Referring to FIGS. 3 and 5, the first timing controller 361 and 362 are connected to corresponding state control signal line pairs, respectively. Logic values transferred via state control signal lines (L11, L12) and (L21, L22) of each pair may constitute a state control signal SC (refer to FIG. 3). That is, the state control signal SC may be formed of two bits. In FIG. 5, the first and second timing controllers 361 and 362 are illustrated, but the third to sixth timing controllers 363 to 366 are configured to be substantially identical to the second timing controller 362.

A timing controller receiving logically ‘Low” and “High” via state control signal lines Li1 and Li2 (i=1, 2, . . . ) of each pair may be a master timing controller. A timing controller receiving logically ‘High” and “Low” via state control signal lines Li1 and Li2 (i=1, 2, . . . ) of each pair may be a slave timing controller. That is, a master-slave control circuit 390 determines a master timing controller and a slave timing controller by sending the state control signal SC to the first and second timing controllers 361 and 362, respectively. In FIG. 5, as an example, the first timing controller 361 is a master timing controller, and the second timing controller 362 is the first slave timing controller. The third to sixth timing controllers 363 to 366 not illustrated in FIG. 5 may operate as the second to fifth slave timing controllers, respectively.

The master timing controller 361 includes a master fail detector 411, a master fail mode operator 421, a master operating signal generator 431, a master detecting pad 441, and a master operating pad 451.

The master fail detector 411 detects the first image signal RGB1 and control signals H, V, and CLK. If a fail is detected, the master fail detector 411 may produce a fail detecting signal FDS that is logically “High”. Likewise, the first slave fail detector 412 detects the second image signal RGB2 and the control signals H, V, and CLK. If a fail is detected, the slave fail detector 412 may produce a fail detecting signal FDS that is logically “High”. In FIG. 5, it is illustrated an example that a fail is detected from the first slave fail detector 412.

The master fail mode operator 421 produces the first substituting image signal SRGB1 in response to an input of a fail operating signal FOS.

The master operating signal generator 431 includes the first logic gate G1 and the first multiplexer M1. The first logic gate G1 outputs the fail operating signal FOS that is logically “High” when a logically “High” signal is received from the master fail detector 411 or the master detecting pad 411. An output line of the first logic gate G1 is connected to the first multiplexer M1 and the fifth logic gate G5.

The first multiplexer M1 is connected with the second master state control signal line L12. The first multiplexer M1 connects one of the first and fourth logic gates G1 and G4 with the master fail mode operator 421 according to a logic value of the second master state control signal line L12. The first multiplexer M1 receives a logically “High” signal via the second master state control signal line L12. At this time, the first multiplexer M1 connects an output line of the first logic gate G1 to the master fail mode operator 421.

The master timing controller 361 receives the fail detecting signal FDS via the master detecting pad 441. The master detecting pad 441 includes the second and third logic gates G2 and G3 and a first NMOS transistor NT1. The second logic gate G2 is connected to the second master state control signal line L12 and the detecting line DL. The second logic gate G2 performs a NAND operation. If the second master state control signal line L12 is set to a logic high level, the second logic gate G2 inverts a logic value of the detecting line DL. For example, when the detecting line DL is set to a logic low level, the second logic gate G2 outputs a “High” signal.

The third logic gate G3 is connected to the first master state control signal line L11 and the master fail detector 411. The third logic gate G3 performs an AND operation, whose output is connected to the gate of the first NMOS transistor NT1. If the first master state control signal line L11 is set to a logic low level, the third logic gate G3 outputs a “Low” level signal regardless of a logic value from the master fail detector 411. That is, the third logic gate G3 is inactivated. Although the fail detecting signal FDS is output from the master fail detector 411, the first NMOS transistor NT1 is not turned on. As a result, the master detecting pad 441 is an input pad which receives the fail detecting signal FDS from the detecting line DL.

The master operating pad 451 may transfer the fail operating signal FOS from the first logic gate G1 to the operating line OL. The master operating pad 451 includes the fourth and fifth logic gates G4 and G5. The fourth logic gate G4 is connected with the first master state control signal line L11 having a logic low level. The fourth logic gate G4 performs an AND operation. Accordingly, the fourth logic gate G4 outputs a logic low level regardless of an output of the fifth logic gate G5. That is, the fourth logic gate G4 is inactivated.

The fifth logic gate G5 is connected with the second master state control signal line L12 having a logic high level. The fifth logic gate G5 performs an AND operation. An output of the fifth logic gate G5 may be changed according to a logic value from the first logic gate G1. As a result, the master operating pad 451 is an output pad which transfers the fail operating signal FOS to the operating line OL.

The first slave timing controller 362 includes the first slave fail detector 412, the first slave fail mode operator 422, a first slave operating signal generator 432, a first slave detecting pad 442, and a first slave operating pad 452.

The first slave fail detector 412 detects the second image signal RGB2 and the control signals H, V, and CLK. Upon detecting of a fail, the first slave fail detector 412 produces the fail detecting signal FDS having a logic high level. The first slave fail mode operator 422 generates the second substituting image signal SRGB2 in response to the fail operating signal FOS having a logic high level.

The first slave operating signal generator 432 includes the second multiplexer M2 and the sixth logic gate G6. The second multiplexer M2 connects an output line of the sixth logic gate G6 or an output line of a ninth logic gate G9 with the slave fail mode operator 422 based upon a logic value of the second slave state control signal line L22. When the second slave state control signal line L22 is set to a logic low level, the second multiplexer M2 connects an output line of the ninth logic gate G9 with the first slave fail mode operator 422. Accordingly, the first slave fail mode operator 422 receives an output of the ninth logic gate G9 regardless of a logic value from the sixth logic gate G6.

An output of the sixth logic gate G6 is not transferred to the operating line OL. In particular, the tenth logic gate G10 receives a logic low level from the second slave state control signal line L22. An output value of the tenth logic gate G10 is not changed according to an output of the sixth logic gate G6.

The first slave detecting pad 442 includes seventh and eighth logic gates G7 and G8 and a second NMOS transistor NT2. The seventh logic gate G7 receives a logic low level from the second slave state control signal line L22. The seventh logic gate G7 performs a NAND operation. Accordingly, an output of the seventh logic gate G7 is not changed according to a logic value of the detecting line DL since the second slave state control signal lien L22 is set to a logic low level.

The eighth logic gate G8 receives a logic high level of the first slave state control signal line L21. Accordingly, an output level of the eighth logic gate G8 may be determined according to an output of the first slave fail detector 412. The output of the eight logic gate G8 is connected to the gate of the second NMOS transistor NT2, which may thus be turned on according to an output of the eighth logic gate G8.

In an exemplary embodiment, if the fail detecting signal FDS having a logic high level is produced from the first slave fail detector 412, the eighth logic gate G8 may output a logic high level, so that the second NMOS transistor NT2 is turned on. This means that the detecting line DL is grounded.

A power supply voltage VDD is applied to the detecting line DL via an impedance element. In FIG. 5, there is exemplarily illustrated the case that the power supply voltage VDD is applied to the detecting line DL via a resistor R. That is, when no fail detecting signal FDS is generated, the detecting line DL is set to a logic high level. When the second NMOS transistor NT2 is turned on, a logic value of the detecting line DL is changed from “High” to “Low”. That is, the first slave detecting pad 442 inverts a logic value of the fail detecting signal FDS from the first slave fail detector 412. As a result, the first slave detecting pad 442 is an output pad which transfers the fail detecting signal FDS to the detecting line DL.

The first slave operating pad 452 includes the ninth and tenth logic gates G9 and G10. The ninth logic gate G9 receives a logic high level via the first slave state control signal line L21. The ninth logic gate G9 performs an AND operation. Accordingly, an output level of the eighth logic gate G9 is determined according to a logic value received via the operating line OL. An output of the ninth logic gate G9 is transferred to the first slave fail mode operator 422 via the second multiplexer M2. Accordingly, the first slave fail mode operator 422 receives the fail operating signal FOS via the first slave operating pad 452.

The tenth logic gate G10 receives a logic low level via the second slave state control signal line L22. An output of the tenth logic gate G10 is not changed according to a logic value from the sixth logic gate G6. That is, the tenth logic gate G10 is inactivated. As a result, the first slave operating pad 452 is an input pad which receives the fail operating signal FOS from the operating line OL.

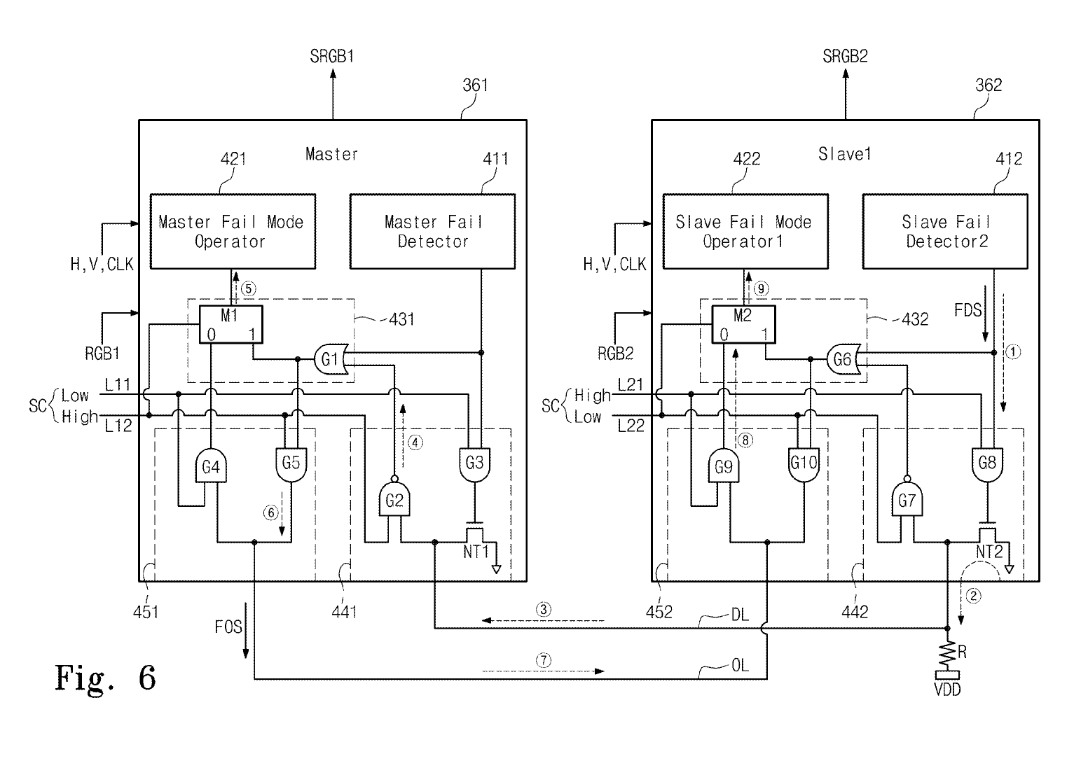

FIG. 6 is a diagram for describing an operation of timing controllers when a fail detecting signal is produced from the first slave fail detector. Referring to FIG. 6, the first slave fail detector 412 generates a fail detecting signal FDS having a logic high level (\textcircled{1}).

The first slave detecting pad 442 inverts a logic value of the fail detecting signal FDS to output an inverted version of the fail detecting signal FDS. That is, the second NMOS transistor NT2 is turned on, and the fail detecting signal FDS having a logic low level is transferred to a detecting line DL (\textcircled{2}). The fail detecting signal FDS is transferred to the master detecting pad 441 via the detecting line DL (\textcircled{3}).

The master detecting pad 441 inverts a logic value of the fail detecting signal FDS received via the detecting line DL to output an inverted version of the fail detecting signal FDS. That is, the second logic gate G2 receives a logic low level via the detecting line DL and outputs a logic high level (\textcircled{4}).

The first logic gate G1 receives a logic high level from the second logic gate G2 and outputs a fail operating signal FOS having a logic high level. The fail operating signal FOS is transferred to the master fail mode operator 421 (\textcircled{5}).

As a logic high level is received from the first logic gate G1, the fifth logic gate G5 outputs a logic high level (\textcircled{6}). A logic value of the operating line OL is changed from “Low” to “High”. That is, the master operating pad 451 transfers the fail operating signal FOS received from the master operating signal generator 431 to the operating line OL. The fail operating signal FOS is sent to the first slave operating pad 452 via the operating line OL (\textcircled{7}).

The ninth logic gate G9 receives a logic high level from the operating line OL to output a logic high level (\textcircled{8}). That is, the first slave operating pad 452 transfers the fail operating signal FOS to the second multiplexer M2. The fail operating signal FOS is sent to the first slave fail mode operator 422 via the second multiplexer M2 (\textcircled{9}). The first slave fail mode operator 422 may generate the second substituting image signal SRGB2 in response to the fail operating signal FOS.

Although not illustrated in FIG. 6, the second to fifth slave timing controllers 362 to 366 may receive the fail operating signal FOS. The second to fifth slave timing controllers 362 to 366 may generate the third to sixth substituting image signals (not shown) in response to the fail operating signal FOS.

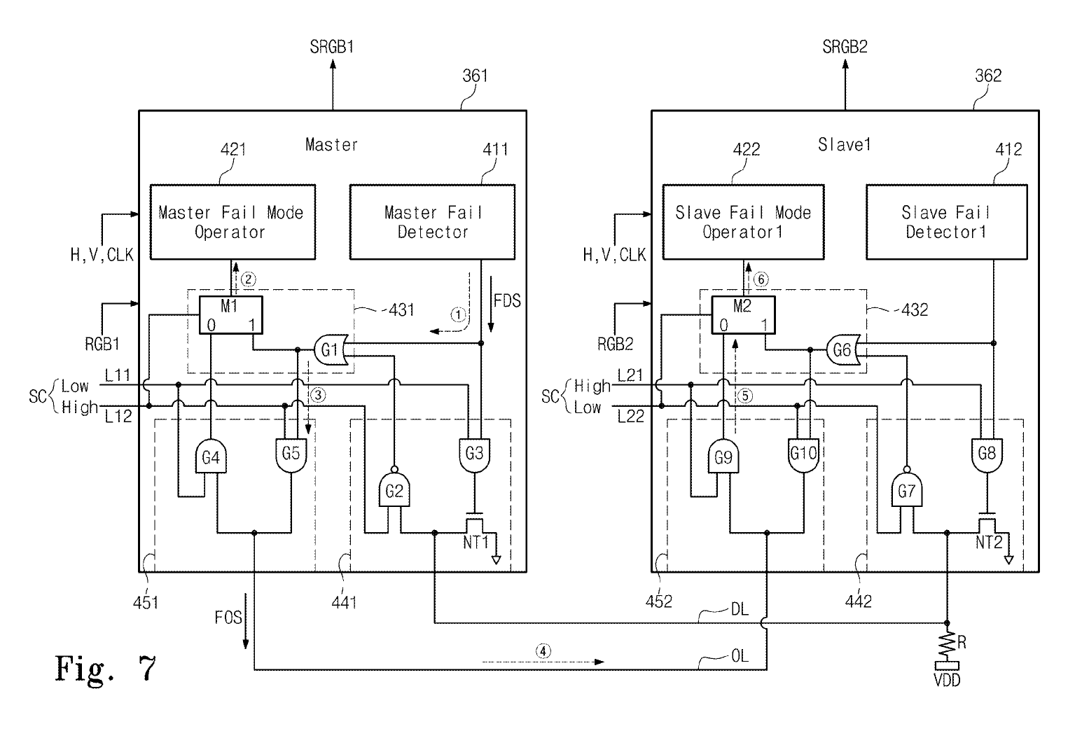

FIG. 7 is a diagram for describing an operation of timing controllers when a fail detecting signal is produced from a master fail detector. Referring to FIG. 7, the master fail detector 411 generates a fail detecting signal FDS having a logic high level (\textcircled{1}).

The first logic gate G1 generates a fail operating signal FOS having a logic high level in response to a high level of the fail detecting signal FDS. The fail operating signal FOS is transferred to a master fail mode operator 421 (\textcircled{2}). The master fail mode operator 421 may generate the first substituting image signal SRGB1 in response to the fail operating signal FOS.

The fifth logic gate G5 receives the fail operating signal FOS from the first logic gate G1 (\textcircled{3}). The fifth logic gate G5 outputs a logic high level. That is, a master operating pad 451 transfers the fail operating signal FOS to an operating line OL. The fail operating signal FOS may be sent to the first slave operating pad 452 via the operating line OL (\textcircled{4}). The ninth logic gate G9 transfers the fail operating signal FOS to the second multiplexer M2 (\textcircled{5}). The fail operating signal FOS may be transferred to the first slave fail mode operator 422 via the second multiplexer M2 (\textcircled{6}). The first slave fail mode operator 422 may produce the second substituting image signal SRGB2 in response to the fail operating signal FOS.

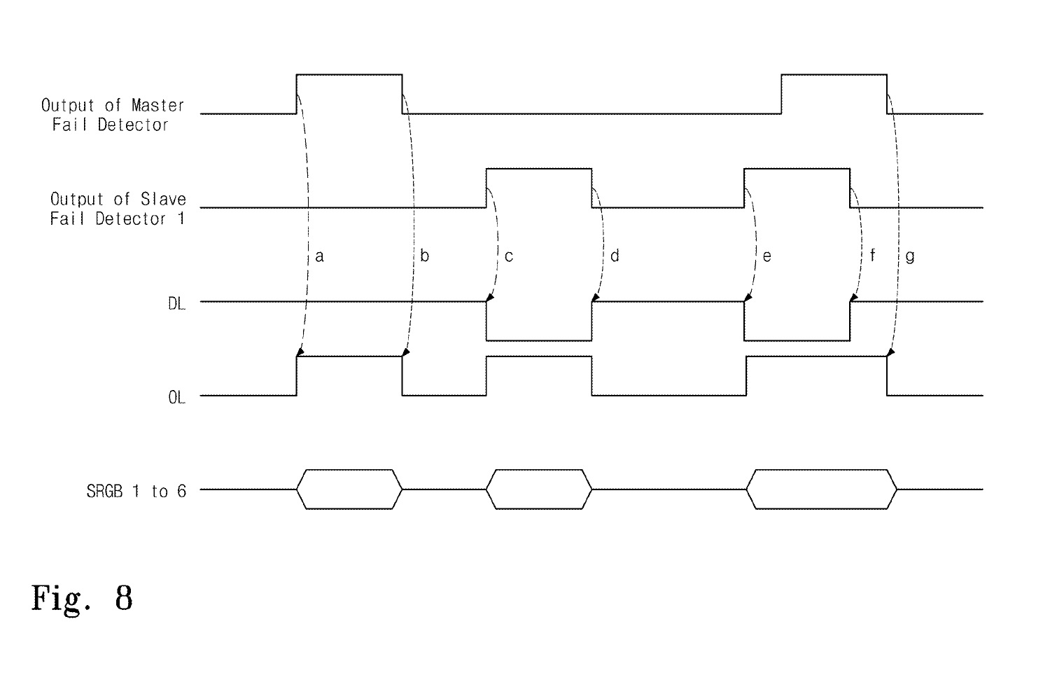

FIG. 8 is a timing diagram for describing a case in which fails are detected from the master timing controller and the first slave timing controller in FIG. 5. FIG. 8 is described under the assumption that a fail is not detected by the second slave to fifth slave timing controllers 363 to 366.

Referring to FIGS. 3, 5, and 8, if the first and second image signals RGB1 and RGB2 are judged to be normal, fail detectors 411 and 412 output a logic low level. At this time, the first to sixth substituting image signals SRGB1 to SRGB6 are not generated.

If a fail detecting signal FDS is generated from the master fail detector 411, an output of the master fail detector 411 transitions from “Low” to “High”. A logic value of an operating line OL goes to “High” (a). That is, if the fail detecting signal FDS is generated from the master fail detector 411, a master timing controller 361 generates a fail operating signal FOS. At this time, the first to sixth substituting image signals SRGB1 to SRGB6 are generated.

If generation of the fail detecting signal FDS is stopped, an output of the master fail detector 411 transitions to “Low”. This means that generation of the fail operating signal FOS is stopped. Accordingly, a logic value of the operating line OL may transition to a logic low level (b). Generation of the first to sixth substituting image signals SRGB1 to SRGB6 is stopped.

If the fail detecting signal FDS is generated from the first slave fail detector 412, an output of the detector 412 transitions from “Low” to “High”. A logic value of a detecting line DL may be changed from “High” to “Low” (c). A master timing controller 361 may produce the fail operating signal FOS in response to the fail detecting signal FDS. A logic value of the operating line OL is changed to “High”. The first to sixth substituting image signals SRGB1 to SRGB6 may be generated.

If the first slave fail detector 412 transitions to “Low”, a logic value of the detecting line DL goes to “High” (d). That is, if generation of the fail detecting signal FDS is stopped, a logic value of the detecting line DL becomes high. A master timing controller 361 may stop generating the fail operating signal FOS. Accordingly, a logic value of the operating line OL goes to a low level. Generation of the first to sixth substituting image signals SRGB1 to SRGB6 is stopped.

When the fail detecting signal FDS is again generated from the first slave fail detector 412, an output of the first slave fail detector 412 is changed to a logic high level. A logic value of the detecting line DL is changed to a logic low level (e). As a logic value of the detecting line DL is changed to “Low”, a logic value of the operating line OL goes to a logic high level. The first to sixth substituting image signals SRGB1 to SRGB6 may be produced.

When an output of the master fail detector 411 goes to a logic high level, a logic value of the operating line OL is previously maintained at a logic high level. The logic value of the operating line OL may be maintained.

When an output of the first slave fail detector 412 is changed to a logic low level, a logic value of the detecting line DL is changed from “Low” to “High” (f). At this time, since an output of the master fail detector 411 is at a logic high level, a logic value of the operating line OL is maintained.

If an output of the master fail detector 411 is changed to “Low”, no fail detecting signal FDS is generated from either of the master fail detector 411 and the first slave fail detector 412. The master timing controller 362 stops generating the fail operating signal FOS. A logic value of the operating line OL may be changed to “Low”. Generation of the first to sixth substituting image signals SRGB1 to SRGB6 is stopped.

According to an exemplary embodiment, if any one of the master and slave timing controllers 361 to 366 produces a fail detecting signal FDS, all of the master and slave timing controllers 361 to 366 may operate at a fail mode. If the fail detecting signal FDS is not produced from the master and slave timing controllers 361 to 366, all of the master and slave timing controllers 361 to 366 may operate at a normal mode.

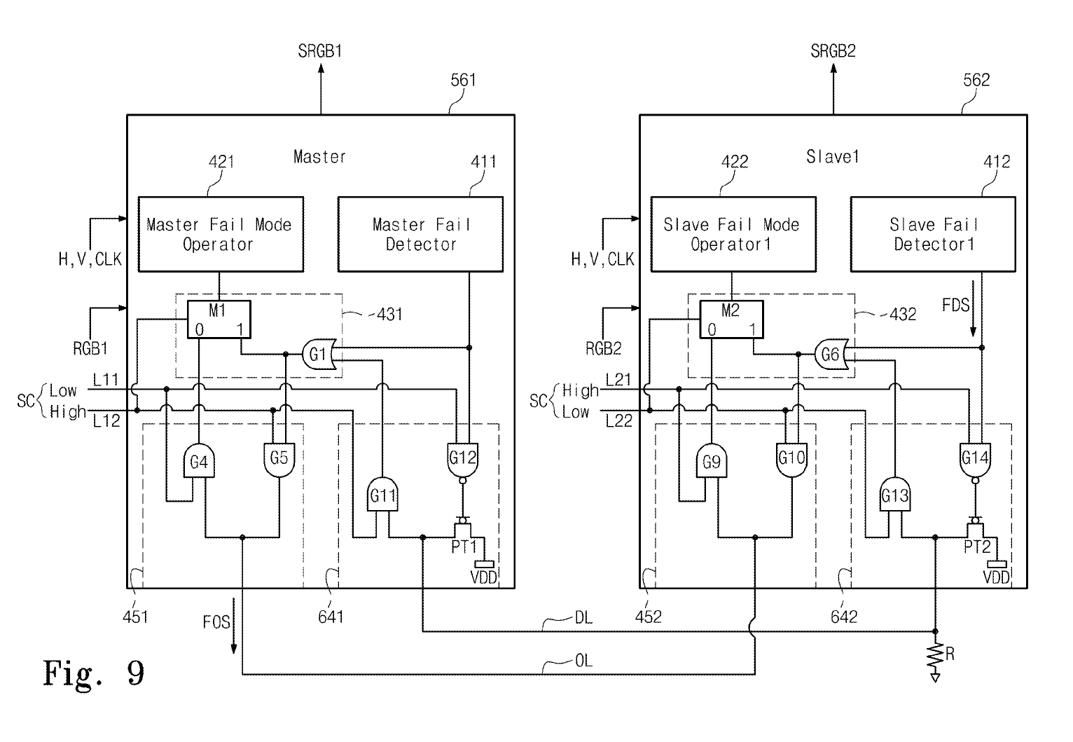

FIG. 9 is a block diagram showing the first and second timing controllers in FIG. 3 according to an exemplary embodiment.

Referring to FIG. 9, a master timing controller 561 is substantially identical to that in FIG. 5 with the exception of a master detecting pad 641, and description thereof is thus omitted. Likewise, the first slave timing controller 562 is substantially identical to that in FIG. 5 with the exception of the first slave detecting pad 642, and description thereof is thus omitted.

A detecting line DL receives a ground voltage via an impedance element. In FIG. 9, as an example, the detecting line DL receives a ground voltage via a resistor R. A voltage level of the detecting line DL may correspond to a ground level before a fail detecting signal FDS is generated.

The first slave detecting pad 642 includes thirteenth and fourteenth logic gates G13 and G14 and second PMOS transistor PT2. The thirteenth logic gate G13 receives a logic low level via the second slave state control signal line L22. The thirteenth logic gate G13 may thus output a logic low level regardless of a logic value received via the detecting line DL. That is, the thirteenth logic gate G13 is inactivated.

The fourteenth logic gate G14 receives a logic high level via the first slave state control signal line L21. The fourteenth logic gate G14 performs a NAND operation. Accordingly, the fourteenth logic gate G14 inverts a logic value received from the first slave fail detector 412.

If no fail detecting signal FDS is produced from the first slave fail detector 412, the fourteenth logic gate G14 may receive a logic low level. At this time, the fourteenth logic gate G14 outputs a logic high level. The second PMOS transistor PT2 is turned off.

If the fail detecting signal FDS is generated from the first slave fail detector 412, the fourteenth logic gate G14 may receive a logic high level. The fourteenth logic gate G14 outputs a logic low level, which turns on the second PMOS transistor PT2, and a power supply voltage is supplied to the detecting line DL. That is, the fail detecting signal FDS having a logic high level may be transferred via the detecting line DL.

The master detecting pad 641 includes eleventh and twelfth gates G11 and G12 and first PMOS transistor PT1. The eleventh gate G11 receives a logic high level via the second master state control signal line L12. The eleventh gate G11 performs an AND operation. An output of the eleventh gate G11 may be determined according to a logic value received via the detecting line DL. In the event that a logic high level is received via the detecting line DL, the eleventh logic gate G11 may output a logic high level. That is, the master detecting pad 641 transfers the fail detecting signal FDS received via the detecting line DL to a master operating signal generator 431.

The twelfth logic gate G12 receives a logic low level via the first master state control signal line L11. The twelfth logic gate G12 performs a NAND operation. The twelfth logic gate G12 may output a logic high level regardless of an output of a master fail detector 411. The first PMOS transistor may maintain a turn-off state.

Unlike that described with reference to FIG. 5, the first slave timing controller 562 in FIG. 9 transfers a fail detecting signal FDS having a logic high level via a detecting line DL.

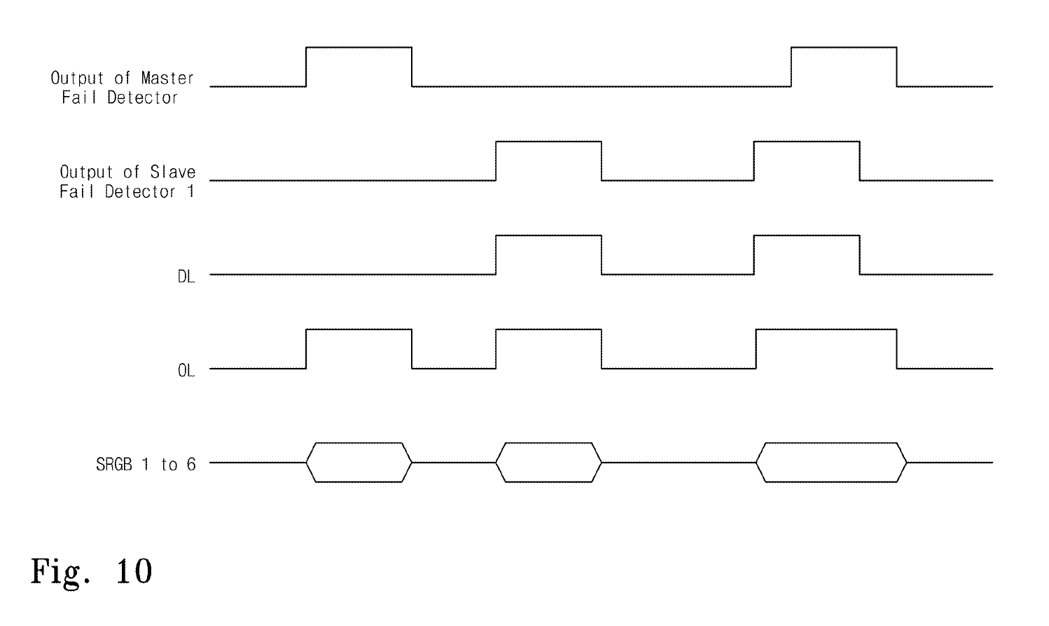

FIG. 10 is a timing diagram for describing a case in which fails are detected from the master timing controller 561 and the first slave timing controller 562 in FIG. 9. A timing diagram in FIG. 10 is substantially identical to that in FIG. 8 except for a logic value of the detecting line DL, and description thereof is thus omitted.

When a fail detecting signal FDS is produced from the first slave fail detector 562, an output of the first slave fail detector 562 transitions from a logic low level to a logic high level. At this time, the detecting line DL may have a low-to-high transition.

When generation of the fail detecting signal FDS at the first slave fail detector 562 is stopped, an output of the first slave fail detector 562 transitions to a logic low level. At this time, a logic value of the detecting line DL may go to a logic low level.

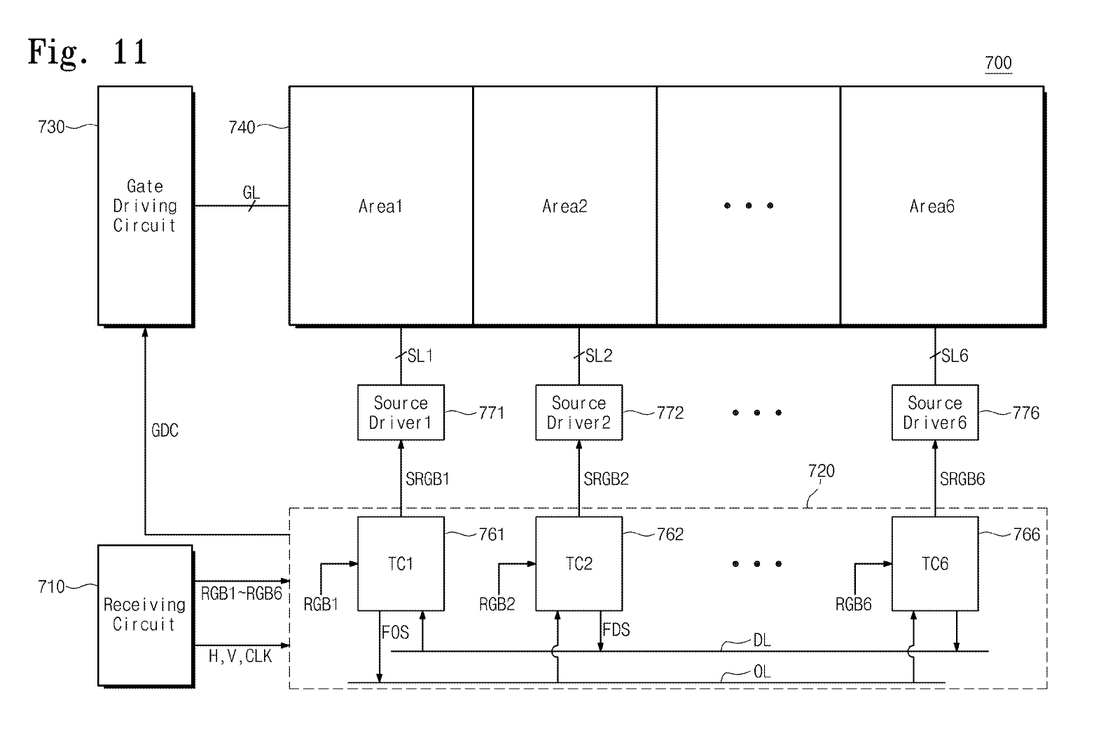

FIG. 11 is a block diagram showing a display device according to an exemplary embodiment.

Referring to FIG. 11, a display device 700 includes a receiving circuit 710, a timing control circuit 720, a display panel 740, and first to sixth source drivers 771 to 776. The elements 710, 730, and 740 are configured to be substantially identical to those in FIG. 1, and description thereof is thus omitted.

The first to sixth timing controllers 761 to 766 are configured to be substantially identical to those in FIG. 1 except that they are not included in the first to sixth source driving parts 151 to 156 (refer to FIG. 1). The first to sixth source drivers 771 to 776 are configured to be substantially identical to those in FIG. 1 except that they are not included in the first to sixth source driving parts 151 to 156 (refer to FIG. 1).

The timing control circuit 720 receives image signals RGB1 to RGB6 and control signals H, V, and CLK. The timing control circuit 720 includes the first to sixth timing controllers 761 to 766.

The first to sixth timing controllers 761 to 766 detect the first to sixth image signals RGB1 to RGB6. Further, the first to sixth timing controllers 761 to 766 detect the control signals H, V, and CLK.

In the event that a fail is detected from any one of the first to sixth timing controllers 761 to 766, the first to sixth substituting image signals SRGB1 to SRGB6 are produced by the first to sixth timing controllers 761 to 766. That is, if any one of the first to sixth timing controllers 761 to 766 detects a fail, they enter a fail mode.

If no fail is detected from the first to sixth timing controllers 761 to 766, the first to sixth timing controllers 761 to 766 may produce the first to sixth image signals RGB1 to RGB6 unlike that described in FIG. 11. That is, the first to sixth timing controllers 761 to 766 operate at a normal mode.

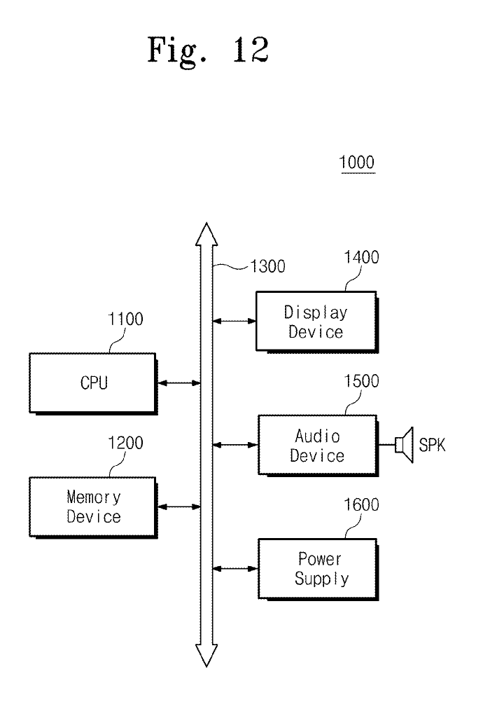

FIG. 12 is a block diagram showing a computing system including a display device according to an exemplary embodiment.

Referring to FIG. 12, a computing system 1000 includes a central processing unit (CPU) 1100, a memory device 1200, a system bus 1300, a display device 1400, an audio device 1500, and a power supply 1600.

The CPU 1100 controls an overall operation of the computing system 1000. The CPU 1100 is connected with the memory device 1200, the display device 1400, the audio device 1500, and the power supply 1600 via the system bus 1300. The CPU 1100 is configured to drive the firmware for controlling the computing system 1000. The firmware may be loaded onto the memory device 1200.

The memory device 1200 includes a volatile memory and a non-volatile memory. The volatile memory is a memory which loses its stored data at power-off. The volatile memory may include a static RAM (SRAM), a dynamic RAM (DRAM), a synchronous DRAM (SDRAM), and the like. The non-volatile memory is a memory which retains its stored data even at power-off. The non-volatile memory may include a read only memory (ROM), a programmable ROM (PROM), an electrically programmable ROM (EPROM), an electrically erasable and programmable ROM (EEPROM), a flash memory, a phase-change RAM (PRAM), a magnetic RAM (MRAM), a resistive RAM (RRAM), a ferroelectric RAM (FRAM), and the like. The memory device 1200 can include a combination of at least two memories of the above-described memories.

The memory device 1200 may store data necessary for driving of the computing system 1000. For example, the memory device 1200 may store an operating system for driving the computing system 1000, an application program, and the like. The CPU 1100 may load the operating system, the application program, and the like onto a volatile memory in the memory device 1200.

A non-volatile memory in the memory device 1200 may be configured to be substantially identical to a memory card or a solid state disk (SSD). The memory device 1200 may include a memory array (not shown) and a controller (not shown) for controlling the memory array.

The display device 1400 may be configured to be identical to that described with reference to FIG. 1, 3, or 11. The display device 1400 receives image signals and control signals (not shown) from the CPU 1100. The display device 1400 is configured to detect the image signals and the control signals and to display a substituting image on a display panel 1400.

The audio device 1500 is connected with a speaker SPK. The audio device 1500 may reproduce audio data according to the control of the CPU 1100. The power supply 1600 supplies a power necessary for driving of the computing system 1000.

Although not shown in FIG. 12, the computing system 1000 may further include an application chipset, a camera image processor (CIS), a modem, and the like.

In some embodiments, the computing system 1000 may be used as computer, portable computer, Ultra Mobile PC (UMPC), workstation, net-book, PDA, web tablet, wireless phone, mobile phone, smart phone, e-book, PMP (portable multimedia player), digital camera, digital audio recorder/player, digital picture/video recorder/player, portable game machine, navigation system, black box, 3-dimensional television, a device capable of transmitting and receiving information at a wireless circumstance, one of various electronic devices constituting home network, one of various electronic devices constituting computer network, one of various electronic devices constituting telematics network, RFID, or one of various electronic devices constituting computing system.

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

What is claimed is:

1. A source driving circuit, comprising:
a master timing controller that controls a first source driver according to a first image signal; and
a slave timing controller that controls a second source driver according to a second image signal,
wherein the master timing controller generates a fail operating signal and a first substituting image signal in response to a fail detecting signal, or if the first image signal is determined to be abnormal; and
wherein the slave timing controller generates a second substituting image signal in response to the fail operating signal.

2. The source driving circuit of claim 1, wherein the master timing controller comprises:
a master fail detector that detects the first image signal; and
a master operating signal generator that generates the fail operating signal according to a detection result of the master fail detector.

3. The source driving circuit of claim 2, wherein the master operating signal generator generates the fail operating signal in response to the fail detecting signal.

4. The source driving circuit of claim 2, wherein the master timing controller further includes a master fail mode operator that generates the first substituting image signal in response to the fail operating signal from the master operating signal generator.

5. The source driving circuit of claim 1, wherein the slave timing controller comprises:
a slave fail detector that detects the second image signal; and
a slave fail mode operator that generates the second substituting image signal in response to the fail operating signal.

6. The source driving circuit of claim 1, further comprising:
a detecting line that connects the master timing controller and the slave timing controller;
wherein the slave timing controller transfers the fail detecting signal to the master timing controller via the detecting line.

7. The source driving circuit of claim 6, wherein the detecting line is connected to a power node via an impedance element, the slave timing controller includes a transistor connecting the detecting line to a ground node according to the fail detecting signal, and the master timing controller generates the first substituting image signal and the fail operating signal if a voltage level of the detecting line is lowered below a threshold.

8. The source driving circuit of claim 6, wherein the detecting line is connected with a ground node via an impedance element, the slave timing controller includes a transistor connecting the detecting line with a power node according to the fail detecting signal, and the master timing controller generates the first substituting image signal and the fail operating signal when a voltage level of the detecting line is increased.

9. The source driving circuit of claim 1, further comprising:
an operating line that connects the master timing controller and the slave timing controller, wherein the master timing controller transfers the fail operating signal to the slave timing controller via the operating line.

10. The source driving circuit of claim 1, wherein the master timing controller and the slave timing controller detect a fail by determining whether at least one of the first and second image signal include a predetermined amount of data.

11. The source driving circuit of claim 1, wherein the slave timing controller generates the fail detecting signal if the second image signal is determined to be abnormal.

12. An operating method comprising:
generating a fail operating signal if a fail is detected from at least one of a plurality of timing controllers, according to a received image signal;
generating substituting image signals by the plurality of timing controllers based on the fail operating signal; and
displaying a substituting image according to the substituting image signals.

13. The operating method of claim 12, wherein the plurality of timing controllers is divided into a master timing controller and a plurality of slave timing controllers, and
wherein the operating method further comprises generating a fail detecting signal if a fail is detected by at least one of the plurality of slave timing controllers.

14. The operating method of claim 13, wherein the generating a fail operating signal comprises generating the fail operating signal, by the master timing controller, in response to the fail detecting signal.

15. The operating method of claim 12, further comprising:
receiving a control signal from an external device; and
displaying an image corresponding to an image signal in response to the control signal if the image signal is determined to be normal by the plurality of timing controllers,
wherein the generating a fail operating signal comprises generating the fail operating signal if a fail is detected from at least one of the plurality of timing controllers.

16. A display device comprising:
a display panel; and
a source driving circuit comprising:
a plurality of timing controllers that control a plurality of source drivers, respectively, according to a received image signal, that generate a fail operating signal if a fail is detected from at least one of the timing controllers, and that generate substituting image signals based on the fail operating signal;
wherein the display panel displays an image based on the received image signal if a fail is not detected, and displays an image based on the substituting image signals if a fail is detected.

17. The display device of claim 16, further comprising:
a master-slave control circuit that outputs a state control signal that divides the plurality of timing controllers into a master timing controller and a plurality of slave timing controllers.

18. The display device of claim 16, wherein the plurality of timing controllers comprises:
a master timing controller that controls a first source driver of the plurality of source drivers according to a first image signal of the received image signal; and
a slave timing controller that controls a second source driver of the plurality of drivers according to a second image signal of the received image signal,
wherein the master timing controller generates the fail operating signal and a first substituting image signal of the substituting image signals in response to a fail detecting signal, or if the first image signal is determined to be abnormal; and
wherein the slave timing controller generates a second substituting image signal of the substituting image signals in response to the fail operating signal.

19. The display device of claim 17, wherein at least one of the plurality of slave timing controllers generates a fail detecting signal if a fail is detected by at least one of the plurality of slave timing controllers, and
wherein the master timing controller generates the fail operating signal based on the fail detecting signal.

20. The display device of claim 18, wherein the slave timing controller generates the fail detecting signal if the second image signal is determined to be abnormal.
